(19) United States
(12) Patent Application Publication
(10) Pub. No.: US 2020/0017359 A1
(43) Pub. Date: Jan. 16, 2020

(54) PROCESS FOR DISPOSAL OF ACID TABLETS

(71) Applicant: US ECOLOGY IDAHO, INC., Boise, ID (US)

(72) Inventors: TERRY GEIS, BOISE, ID (US); KEN KNIBBS, BOISE, ID (US)

(21) Appl. No.: 16/282,202

(22) Filed: Feb. 21, 2019

Related U.S. Application Data
(60) Provisional application No. 62/633,480, filed on Feb. 21, 2018.

(51) Int. Cl. C01B 11/06

(52) U.S. Cl. CPC C01B 11/062

(57) ABSTRACT

A process to generate sodium hypochlorite solution from recycled solid oxidizer materials. The process involves preferably two main units: the chlorine generation unit where a wet gaseous chlorine stream will be generated, and a bleach production unit where the chlorine gas will be combined with caustic soda to create a bleach solution.

### PRIORITY/CROSS-REFERENCE TO RELATED APPLICATIONS

This application claims the benefit of U.S. Provisional Patent Application No. 62/633480, filed Feb. 21, 2018, the contents of which are hereby incorporated by reference.

### FIELD OF INVENTION

The primary goal of this process is to generates a sodium hypochlorite solution from recycled solid oxidizer materials. These oxidizer materials include off-spec materials and out-of date products that must be de-activated prior to disposal. The goal of this process is to deactivate the material while creating a useable end product. A sodium hypochlorite product concentration of 15 wt % at a pH of 13 is the ultimate goal of this process.

### BACKGROUND INFORMATION

A large quantity of oxidizer materials containing chlorine as their active agent, generally used for pool disinfection, are in need of deactivation before they can be disposed of Without de-activation, they are too reactive to be placed in a landfill. The purpose of the process described herein is to prepare a bleach solution from these waste materials with commercial value. There is also potential for the waste acid stream to have commercial value, otherwise it can be used to neutralize compatible alkaline streams at the processing facility prior to disposal.

A study was previously completed to determine the chemistry of the oxidizer materials and the feasibility of the bleach-making process. There are three main types of oxidizer materials:
Calcium hypochlorite tablets (calcium tablets),
Chlorinated isocyanurate tablets (acid tablets), and
Bromine tablets.

The study highlighted potential chemical incompatibilities of the three tablet types, resulting in the need to process the three types separately. Due to the equimolar amounts of bromine and chlorine in the bromine tablets, these products are not capable of producing chlorine gas. Therefore, only the acid and calcium tablets have the potential to be used to create a bleach solution. The generation of chlorine gas from the calcium tablets is fairly straightforward, therefore efforts were focused on developing the bleach-making process for the more complex acid tablets. The goal was to use information gained from testing the acid tablets to design a batch-style production process that would include a rinse/purge step so that this single facility could ultimately be used for processing all three tablet types. (The bromine tablets would only be deactivated in the facility, without the production of the hypochlorite solution.) The pilot plant has been designed to test the acid tablet as required and has the flexibility to add additional process steps as required to test the other two types of materials.

After the chemical feasibility study, a bench-scale study was performed with the acid tablets to determine the parameters required to generate chlorine gas. A detailed report of the bench scale findings is presented in Section 4. The findings from this study are incorporated into the design of the pilot-scale facility. Because some of the acid tablet formulations contain materials that present safety and handling issues (bromine and glycouril), these were not tested during the laboratory study. However, if the pilot plant is successful, these other formulations can be tested in the pilot plant facility once a bench-scale testing program determines the required processing and handling steps and appropriate modifications are made.

### SUMMARY

The primary goal of this process is to generate a sodium hypochlorite solution from recycled solid oxidizer materials. The process will preferably be made up of two main units; the chlorine generation unit where a wet gaseous chlorine stream will be generated, and a bleach production unit where the chlorine gas will be combined with caustic soda to create a bleach solution. In the chlorine generation unit, the oxidizer material will be dissolved in water and then combined with hydrochloric acid to generate the chlorine gas. The chlorine gas from the headspace of this reactor will be bubbled through a sodium hydroxide solution, and the gas will react with the sodium hydroxide to form bleach. The waste material in the chlorine tank will consist of an acidic solution of cyanuric acid (with some other salts depending on the chemical makeup of the oxidizer materials), which has the potential to be commercially viable. Otherwise, this material can be used to neutralize other waste alkaline streams at the facility prior to disposal.

### BRIEF DESCRIPTION OF DRAWINGS

FIG. 1 is a flow chart of the process.

FIG. 2 is a flow chart of the process.

FIG. 3 is a flow chart of the process.

FIG. 4 is a flow chart of the process.

FIG. 5 is a flowchart of the process.

FIG. 6 is a flowchart of the process.

### DETAILED DESCRIPTION

Process Chemistry

This section describes the relevant chemistry for the production of the chlorine gas from acid tablets and the generation of a sodium hypochlorite solution. For detailed information about the chemical formulations of the acid and other tablets, please refer to the “Process Development Report for Hypochlorite Recovery from Recycled Oxidizer Material” dated Sep. 22, 2016, presented in Attachment A.

Chlorine Chemistry of Acid Tablets

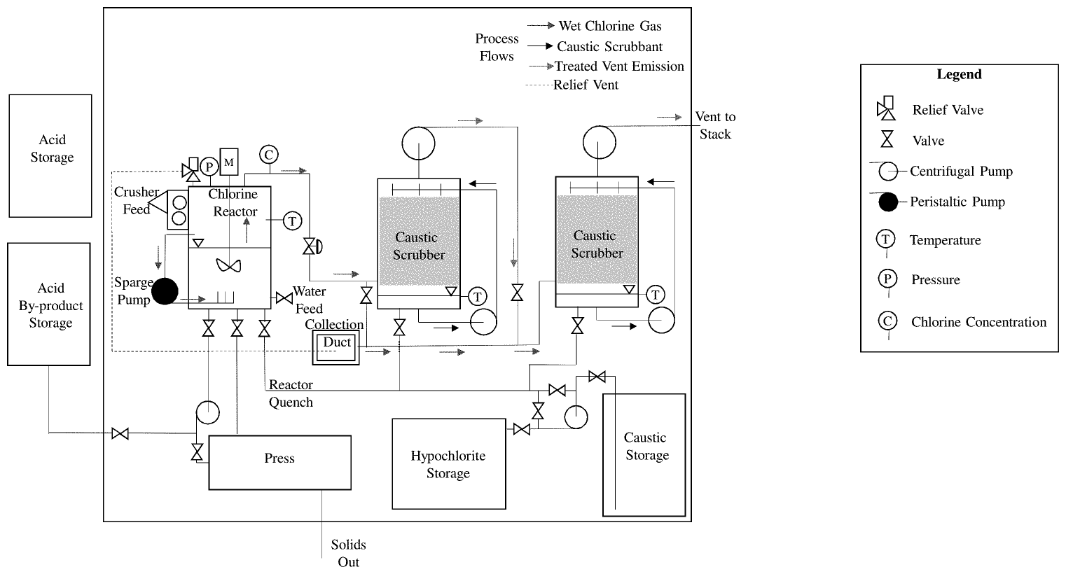

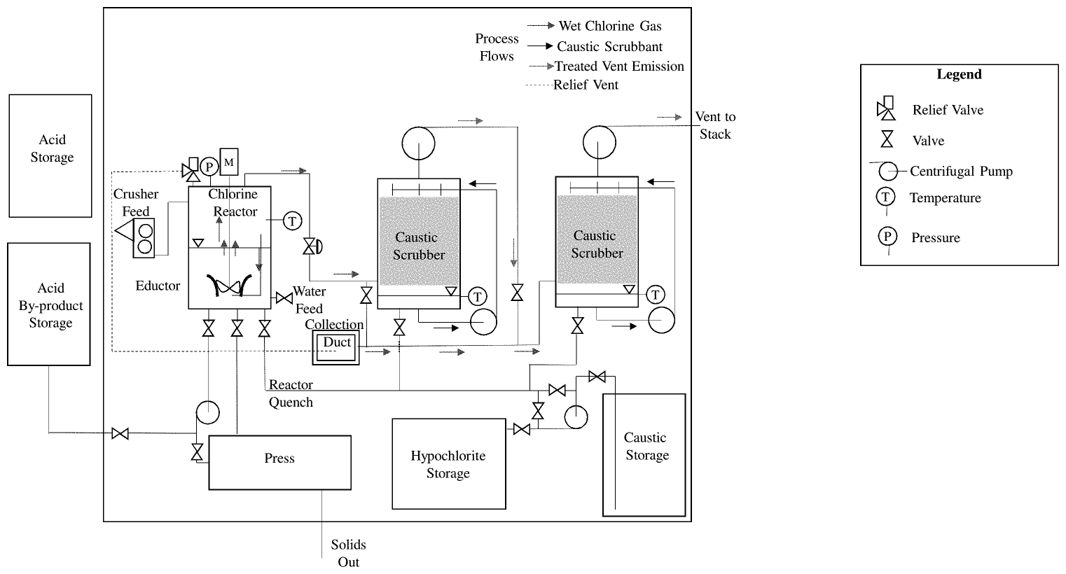

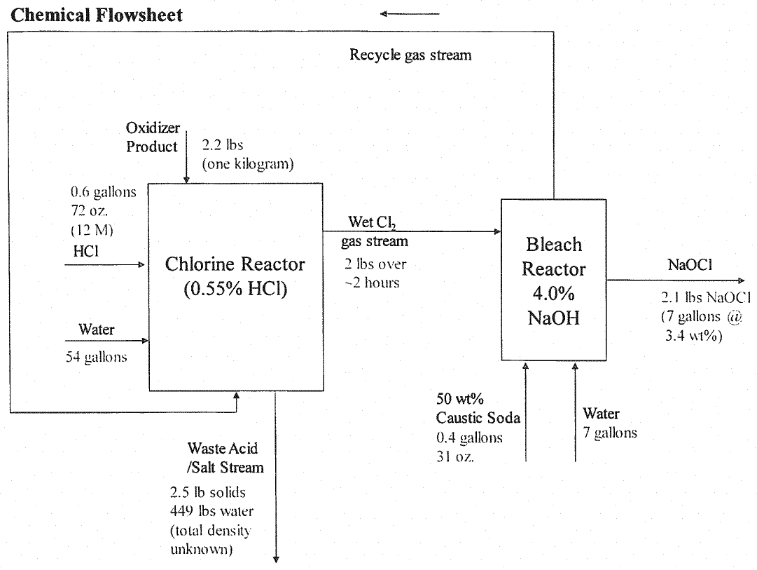

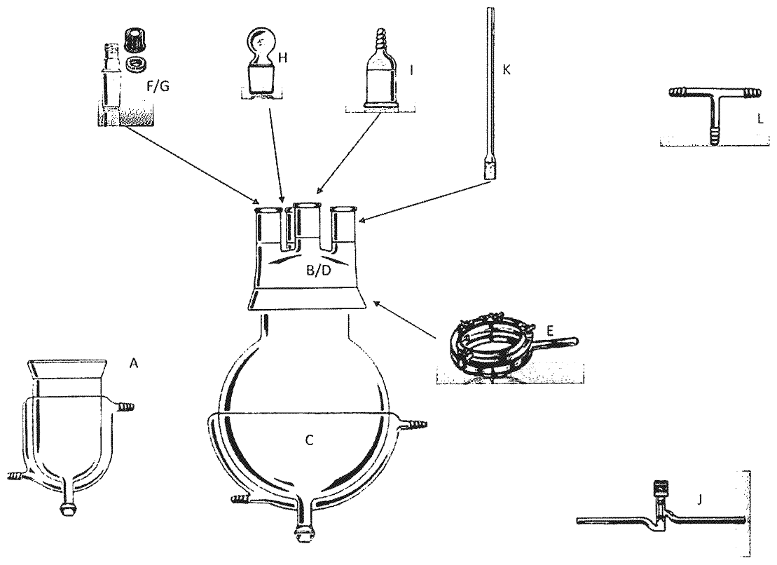

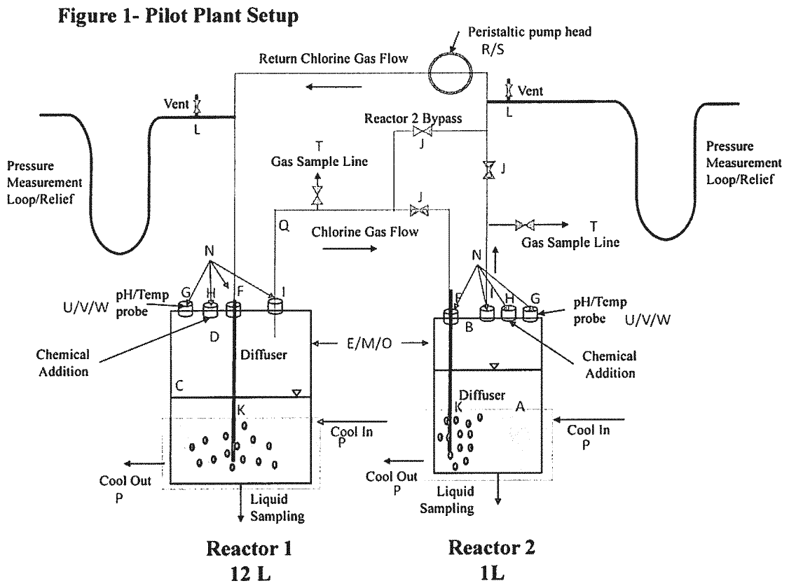

The primary ingredient in the acid tablets is either trichloroisocyanurate (trichlor) or sodium dichloroisocyanurate (dichlor), which are chlorinated forms of isocyanuric acid, shown in FIG. 1. In water, the chlorine atoms will be hydrolyzed to produce a hypochlorite molecule, as shown in FIG. 2. Each of these chlorine hydrolysis reactions is an equilibrium reaction, and each successive reaction has its own equilibrium constant. If the cyanuric acid is represented by Cy, these reactions can be simplified to:

Cl₃Cy+H₂O←→HCl₂Cy+HOCl (1)

HCl₂Cy+H₂O←→H₂ClCy+HOCl (2)

H₂ClCy+H₂O←→H₃Cy+HOCl (3)

The HOCl will react with HCl to produce chlorine gas and water:

HOCl+H⁺+Cl⁻←→Cl_{2(g)}+H₂O (4)

Under acidic conditions (pH<2), equations (1)-(4) favor the forward direction (removal of Cl₂ from the trichlor and generation of Cl₂ gas). The escape of chlorine gas from the solution will further drive these reactions to the right. Cyanuric acid is the final reaction product once all of the chlorine has been removed. Cyanuric acid has a much lower water solubility than any of the chemicals present in the oxidizers, therefore it will tend to precipitate out. Because chlorine gas has a water solubility of about 7,000 mg/L, some portion of it will remain in solution, depending on the equilibrium conditions in the reactor. The pilot has been designed with an air sparger in the chlorine generation tank to ensure efficient removal of the gas from solution so that 1) the maximum bleach yield can be achieved per mass of reactant and 2) the waste stream can be handled safely.

The acid requirements for each product vary by the amount of trichlor and dichlor in the product and the presence of other materials in the formulations that will consume acid. For each mole of trichlor, three moles of HCl are required and for each mole of dichlor, two moles of HCl are required. One mole of sodium tetraborate will quench up to two moles of HCl upon hydrolysis, generating four moles of boric acid, three moles water, and 2 moles NaCl per mole. Free boric acid will not neutralize any HCl. One mole of sodium hexametaphosphate will quench up to six moles of HCl upon hydrolysis to six moles of phosphoric acid. However, phosphoric acid (H₃PO₄) is a strong acid and may only be partially protonated at the pH relevant to Cl₂ production (˜2). Each mole of copper citrate contains two moles of citrate which can quench a combined six moles of HCl per mole of copper citrate. Disodium cyanurate can neutralize up to 2 moles of HCl per mole.

Using these equivalences, the total stoichiometric acid requirement for each formulation could be calculated.

The heat generation of the breakdown of trichlor and dichlor is not reported in the literature. The dilution of HCl also generates heat. However, no significant heat or bubbling were observed under the bench scale conditions, as will be discussed in Section 4.

Hypochlorite Chemistry

Chlorine gas reacts with sodium hydroxide to form sodium hypochlorite (NaOCl), sodium chloride (NaCl), and water by the following reaction:

Cl₂+2 NaOH→NaOCl+NaCl+H₂O (5)

During this reaction, 627 British Thermal Units (BTU) of heat are generated per pound of gaseous chlorine consumed. The dilution of sodium hydroxide in water also generates heat. Therefore, heat generation in the bleach unit has the potential to be significant.

Sodium hypochlorite solutions are unstable. There are two pathways for decomposition of the hypochlorite:

3 NaOCl→NaClO₃+2 NaCl (6)

3 NaOCl→O₂+2 NaCl (7)

Reaction (6) is temperature and concentration dependent. Reaction (7) is catalytic and is catalyzed by trace metals and light. The stability and shelf life of the hypochlorite solution depends on five major factors (OxyChem):
Hypochlorite concentration. Low concentration hypochlorite solutions decompose more slowly than high concentration hypochlorite solutions. Fifteen weight percent sodium hypochlorite will decompose approximately 10 times faster than 5 wt % sodium hypochlorite at 25° C.
pH of the solution. Below pH 11, the decomposition of sodium hypochlorite is significant. A pH between 12 and 13 provides the most stable solution. Greater concentrations will not improve the stability. Excessively high alkalinity will retard the bleaching and disinfecting actions of the hypochlorite.
Temperature of the solution. Higher temperatures increase the decomposition rate. Fifteen percent sodium hypochlorite decomposes five times faster at 45° C. than at 25° C. It is reported that it is best not to exceed 80° F. during chlorination for dilute bleach solutions and 70° F. for concentrated bleach solutions.
Concentration of certain impurities which catalyze decomposition. Trace metals such as nickel, cobalt and copper form insoluble metal oxides, which cause the bleach to catalytically decompose via eq. (7). These trace metals, as well as iron, calcium and magnesium, form sediment and may discolor the bleach solution. Potential sources for these impurities include raw materials, processing equipment and product storage containers. The most common source for these metals, particularly nickel and copper, is the caustic soda.
Exposure to light. Sunlight (ultraviolet light) catalyzes hypochlorite decomposition via eq. (7) Opaque (non-translucent) containers for hypochlorite solutions will reduce decomposition due to light.

The process will target a bleach concentration of 10-20 wt % with a final pH of 13 for stability. The use of filtration or other techniques to control the quality of the final bleach will be incorporated into the full-scale process at that time.

Summary of Bench Scale Testing Data

Prior to the development of this pilot plant design, bench scale testing was performed to determine the chemical requirements for the process flowsheet. Tests were performed to determine the solubility of the products in acid, the reactivity of the products, and the generation rate of the Cl₂ gas. The work plans for these tests are provided in Attachment 2, and the data sheets are provided in Attachment 3.

Three tests were performed with acid tablet formulations provided by Biolabs, Inc. with the exception of tablets containing glycouril or bromine. Glycouril has a potential to form nitrogen trichloride, an explosive, under the acidic reaction conditions. The generation of bromine presented complicated material handling issues. Products containing these materials can be tested after more extensive bench scale testing is performed.

Solubility of Oxidizer Materials

The first test was designed to determine the solubility of the oxidizer products in hydrochloric acid. During these tests, one gram of oxidizer material was mixed with varying volumes of 0.56 M HCl. The products dissolved very slowly when left in chunk size pieces—crushing the material with a mortar and pestle to a fine size was required to allow a reasonable dissolution time. The use of a stir bar also significantly increased dissolution times. No significant heat generation or gassing was noted during this testing.

Due to the quick reactivity of the materials in the acid, determining a true solubility of the oxidizer products was not possible. Because the materials reacted so quickly, cyanuric acid (the reaction product) became the limiting factor in the solubility of the materials. The design of the test resulted in a final cyanuric acid concentration of 5,500 mg/L versus the 2,700 mg/L solubility limit. Therefore, significant solids settled out during these experiments but were easily re-solubilized upon addition of more DI water. The presence of cyanuric acid in the solids was confirmed using GC/MS. One product containing 99% trichlor by weight was also tested in pure DI water, and the solubility approached 30,000 mg/L, which is much higher than the reported solubility of 12,000 mg/L. The solubility experiments were ultimately discontinued because the reactivity and solubility of the product in acid could not be differentiated. However, important information about the dissolution, heat generation and off-gassing were obtained.

Acid Requirements

The second test was designed to determine the acid requirements for driving the chlorine removal to completion. In these tests, varying amounts of acid (ranging from the stoichiometric amount to approximately six times this amount) were added to one gram of material and allowed to react overnight. The remaining solution was then titrated to determine the amount of acid used in the experiment. Approximately two times the stoichiometric acid amount is required to drive the reaction to completion. Once again, no significant heat generation (no temperature changes) or strong reactivity was noted in any of these tests.

Chlorine Gas Generation

The final test was designed to determine the chlorine generation rate as a function of time after acid addition. One gram of material was reacted with 100 mL total liquid volume—including enough 12M acid to contribute twice the stoichiometric acid requirement for the product and the balance DI water. A closed system was set up for the reactor with the reaction vessel connected to a hydraulic loop so that the pressure increase of the system could be monitored with time (as a difference in water height). Using the ideal gas law, the pressure change in centimeters of water was related to the mass of Cl₂ entering the atmosphere in the reaction vessel.

The testing showed that the chlorine gas generation is exponential with the majority of the release happening within 120 minutes. FIG. 3 shows the pressure versus time for the experiments that were conducted. Based on the calculations of the amount of chlorine present in the atmosphere above the reaction and the use of excess acid to drive the reaction to completion, it was determined that a significant portion of the chlorine remains solubilized in the water (as expected due to its high solubility). This system was under pressure, so more of the chlorine will remain in solution than in the process. However, it is anticipated that sparging will be required to strip all of the chlorine gas from solution.

Based on the findings of these experiments, a headspace model was constructed to estimate the range of chlorine concentrations that can be expected in the atmosphere above the chlorine tank and the outlet of the scrubber. This model was based on the kinetic information obtained in the bench scale experiments, and used conservative estimates for the sparger efficiency. The model indicated that the concentration could be as high as 61% (by volume) or 612,000 ppm with a moderate estimate of about 50% or 500,000 ppm. Assuming a 99% efficiency in the bleach tank, this would result in an outlet concentration as high as 6,120 ppm. Therefore, the recycle from the scrubber outlet back through the chlorine process is essential to capture all of the chlorine generated and to bring the chlorine levels down to a reasonable level.

The following key findings were used in the design of the pilot process:
1. Crushing of the pucks and agitation are required for a reasonable dissolution timeframe.
2. The limiting factor for solubility in the system is the reaction product, cyanuric acid. Solids formed during the reaction re-dissolve easily upon the addition of more water.
3. No significant heat generation or reactivity was noted upon the addition of the acid, even when 12 M acid was added to the water/oxidizer mixture.
4. Approximately two times the stoichiometric acid is required to drive the reaction to completion.
5. Chlorine gas generation is exponential with the majority of the release happening within 120 minutes; air sparging is required to drive all chlorine from solution; very high concentrations of chlorine gas can be expected in the headspace of the reactor and the outlet of the bleach tank at the initial stages of the reaction.

Pilot Plant Description

Purpose

The purpose of the pilot plant is to test a complete system from the generation of chlorine gas to the production of bleach. A larger quantity of material (35×the bench scale) will be used to discern scale-up issues. The objectives of the pilot plant are as follows:
Determine the chemical requirements for a full-scale process;
   Hydrochloric Acid and Sodium Hydroxide
Minimize the amount of water required and waste produced;
Measure heat generation to determine thermal requirements (cooling, etc.);
Quantify the trichlor/dichlor breakdown kinetics as a function of system parameters;
Determine the chlorine gas concentration in the system as a function of time and system parameters;
Determine the optimal batch sequence;
   Chemical addition rates and heel sizes
Explore mixing of the compatible products within batches;
Determine required sparge and mixing energies for the vessels;
Determine the commercial viability of the waste cyanuric acid stream;
Optimize the gas flow rate through the system;
Test equipment chemical/material compatibility and functionality;
Determine inputs for in-line chlorine gas analyzer (for full scale)
Determine inputs for design of full-scale bleach system (envisioned to be an appropriately sized, off-the-shelf design); and
Determine ability to target final bleach product.

Chemical Flowsheet

Using the data collected from the batch experiments and industry knowledge of the bleach-making process, a baseline chemical flowsheet was developed. FIG. 4 presents the flowsheet, which is based on processing 35 grams of material. The values on FIG. 4 are for product number R10808 which is 99% trichlor. Process numbers for the other products are presented in Table 1. Note that all of these calculations are estimates based on stoichiometry (and the bench scale acid testing). The actual yield and chemical requirements will be determined during the testing phase.

As shown, 35 grams of material will be combined with 7 liters of water in a reactor. This amount of water allows for all of the cyanuric acid generated to remain soluble. One of the goals of the pilot testing phase will be to determine the minimum amount of water that can be used to successfully process the material. Once the water and oxidizer mix, 73 mL of 12M HCl will be added. The reaction will produce 31 grams of chlorine gas, 35 g of cyanuric acid and 7L of dilute HCl. The density of the waste solution is not known at this time but will be determined in the testing phase.

The majority of the chlorine gas evolution is expected to occur over approximately two hours. The chlorine gas will be bubbled through 37 g of 50 wt % NaOH that has been diluted with 185 g of soft or deionized water. This will produce 185 mL of a 15 wt % sodium hypochlorite stream at a pH of 13. The heat generated during this reaction is estimated to raise the temperature by 80° F. In the initial testing phases, the NaOH may be diluted so that the estimated temperature increase is not a safety or quality concern. This will allow for evaluation of actual temperature changes and heat generation without using the cooling jacket on the bleach reactor. Once sufficient data is obtained about the heat generation, the cooling unit can be used and the target bleach concentration can be made.

Process Equipment and Flow

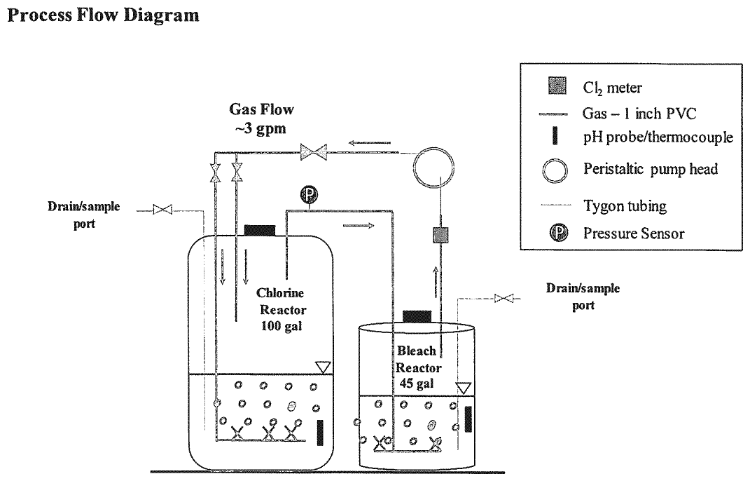

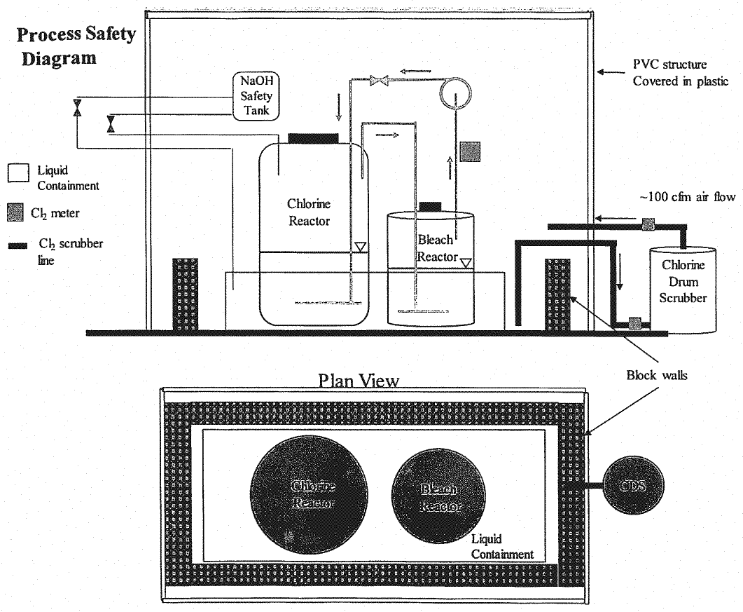

The Process Flow diagram is presented in FIG. 5. The chlorine reactor will consist of a 12 L glass reaction vessel with a removable lid. The lid has four entry points that can accept multiple glass adaptors. The reactor will be equipped with a combined pH/thermocouple probe and a coarse bubble air sparger that will be used to strip chlorine gas and to agitate the material in the reactor. Pressure will be estimated in the reactor with a static barometric liquid loop. This loop will also serve as pressure relief for the overall system. If the system pressure increases beyond the column height of water, the water will be pushed out of the tubing and the system will vent to the hood. Tygon tubing (compatible with chlorine gas) will be attached to a hose barb adaptor to connect the chlorine reactor to the bleach reactor. A peristaltic pump will be used to pump the vapor space of the chlorine tank to the bleach tank. This vapor stream will be looped back through the air sparger in the chlorine reactor until the outlet chlorine concentration from the bleach tank is de minimus.

A 1 L glass reactor will be used for the bleach generation unit. This reactor will be equipped with a combined pH/thermocouple probe and a coarse bubble air sparger that will contact the chlorine stream with sodium hydroxide and agitate the material in the reactor. Pressure will be estimated in the reactor with a static barometric liquid loop.

Gas sampling ports will be located downstream of the chlorine and bleach reactors so that both concentrations can be sampled. Several valves are located on the system to allow for gas bypass of the bleach tank if needed.

Monitoring the Process

Establishing the kinetics of the trichlor and dichlor breakdown will be an initial goal of the pilot testing, as well as determining the key process parameters. The following variables will be monitored during various trails:

1. Measurement of the of cyanuric acid concentration (the primary reaction product) in the chlorine reactor liquid as a function of time via liquid sampling from the reactor. This is the only direct measurement of the trichlor/dichlor breakdown kinetics because it is not dependent on other physical system variables.

2. Measurement of chlorine concentrations (and water content) as a function of time in the chlorine reactor and in the exit stream from the bleach reactor via gas sampling. This concentration is dependent on the liquid-air mass transfer mechanisms that influence the release of chlorine, on temperature changes in the system, and on the concentration in the return stream from the bleach reactor. An impinger sampling train (Method 26-A) will be used to measure the chlorine concentration, and will capture the mass of chlorine gas over the sampling time period. Several sample trains will be used to sample at designated intervals over the expected reaction phase to establish the chlorine concentration as general function of time. The transient chlorine concentration will be established during small number of trials, and will be qualitatively correlated with other process variables so that these variables can be used to monitor the extent of reaction in successive trials.

3. Measurement of bleach concentrations as a function of time in the bleach reactor via liquid sampling. This measurement is dependent on the mass transfer efficiency of the bleach unit. 4. Measurement of reactor pressures with the barometric loops. The pressure change

in the tank will be proportional to the mass of chlorine gas generated (based on the ideal gas law relation PV=nRT).

5. Measurement of pH and temperature. The pH in the chlorine reactor will go up and the pH in the bleach unit will go down as the reaction progresses. Temperatures will increase as a function of the reaction.

Note that measurements 1 and 2 are indirect and data will not be available for several weeks. These measurements cannot be taken during the same trial due to the loss of mass from the system (e.g. taking the liquid sample will reduce the overall Cl₂ generated so gas samples will not be taken at the same time as liquid samples). Measurements 4 and 5 are instantaneous and an attempt will be made to correlate these to the indirect measurements. In order to have instantaneous feedback as to when the reaction is complete, a low-range chlorine monitor (0-250 ppm range) will be placed on the outlet of the bleach tank. Based on the headspace model, this monitor can be turned on about 3 hours into the reaction to begin to monitor the outlet concentrations from the bleach tank. Once the concentration is below detection, the recycling of the gas can be stopped.

To aid in the sample collection, liquid and gas sample ports will be located on each tank. These sample ports will also be used to drain the tanks and to add acid to the chlorine tank. Gas sample ports are located on the tubing from the headspace of each tank.

Process Safety

The main hazard in the process is the release of high concentrations of chlorine gas. The OSHA-IDLH for chlorine is 10 ppm (29 mg/m³) and the 15-minute ceiling limit is 1 ppm (2.9 mg/m³). The maximum amount of chlorine gas that can be generated in one batch is 32 grams and the highest concentration modeled was 61.2wt % or 612,000 ppm. All testing will take place under a laboratory hood, and a chlorine monitor will be used to determine if leaks are occurring from the unit. If needed, the chlorine reaction can be quenched by adding sodium hydroxide to the reactor. A detailed procedure is included for this circumstance.

Pilot Plant Test Plan

The test plan will consist of several phases, with each designed to meet the goals of the pilot plant. The phases include the following:
1. Water Testing;
2. Open-system testing;
3. Closed-system testing;
4. Closed system testing using an in-line chlorine gas analyzer;
5. Extra testing as needed.

The following sections outline each phase. Detailed procedures are provided in Appendix 1.

Water Testing

During this phase, all of the equipment will be set up in the AquAeTer laboratory and tested for overall functionality. All equipment and operations that will be used/performed during the chemical procedures will be tested. A soap/water solution will be used to determine the leak tightness of the system. No other chemicals will be used. Once the system is configured correctly, the system will be documented photographically, taken apart, and shipped to the final testing location.

Open-System Testing

In this phase, the system will be run without recycling the exit stream from the bleach reactor to the chlorine reactor. This will allow evaluation of the sparge efficiency, and outlet chlorine concentrations in both reactor systems without the interference of the recycled chlorine. All direct process parameters will be recorded and compared to the closed-system testing to determine the impact of the recycled stream. This phase will help meet the goals of (1) determining the chlorine gas concentration in the system as a function of time and system parameters (2) quantifying the bleach and chlorine reactor sparge efficiencies and (3) determining inputs for in-line chlorine gas analyzer.

Closed-System Testing

In this phase, the system will be run as designed with the recycle loop. The majority of the testing will take place in this phase. The goals that will be met during this phase are listed below with an explanation of what methodology will be used to meet the objective.

| Goal | Methodology |
|---|---|
| Determine the chemical requirements for a | Compare testing results (final concentrations |
| full-scale process. | and extent of reaction) to calculation |
| | estimates, adjust amounts as needed. |
| Determine the optimal batch sequence. | Evaluate the impact of a liquid heel and other |
| | batching variations on the kinetics and bleach |
| | final product quality. |
| Explore mixing of the compatible products | Once testing with each product has taken |
| within batches. | place, mixtures will be analyzed to determine |
| | if any issues arise. |
| Optimize the gas flow rate through the system | Evaluate mixing (visually) and Cl₂ generation |
| and determine required sparge and mixing | curves as a function of gas flow rate. The |
| energies for the vessels. | data from this phase will be used in |
| | conjunction with data from the Open-System |
| | testing. |
| Determine ability to target final bleach | Bleach concentration and final pH will be |
| product quality. | monitored, as well as the stability of the final |
| | product over time. |
| Measure heat generation to determine thermal | Measure temperature vs. time in each reactor, |
| requirements (cooling, etc). | use known volumes to calculate heat |
| | generation, compare to literature values. |
| Quantify the trichlor/dichlor breakdown | Measure cyanuric acid in the chlorine reactor |
| kinetics as a function of system parameters. | as a function of time for varying batch |
| | scenarios. |
| Minimize the amount of water required and | Experiments will be repeated with decreasing |
| waste produced. | volumes of water in the chlorine reactor. The |
| | reactor contents will be neutralized and the |
| | cyanuric acid resolubilized to determine the |
| | final concentration (and therefore total mass of |
| | cyanuric acid) to determine extent of the |
| | reaction. |

Closed System Testing Using an In-Line Chlorine Gas Analyzer

This phase of testing will be conducted after an in-line gas analyzer is purchased. The selection of the analyzer will be informed by the results of the previous testing. The final flowsheet, as determined by the previous tests, will be run using the gas analyzer. This phase will help meet the goal of determine inputs to the design of full-scale bleach system. The chlorine concentration vs. time and humidity, as well as other process variable such as temperature and pressure will be used by the design team when developing the bleach system.

Health And Safety

The Chemical Hygiene Plan for the Grandview laboratory, Section 17 of the US Ecology Idaho, Inc Health and Safety Plan, will be followed for this testing. This section highlights additional health and safety information that is specific to this testing. However, USE personnel should review the testing protocol and ensure that their current Chemical Hygiene program is sufficient for these activities.

Reagent Hazards

The reagents used in this testing include the following:
1M HCl
1M NaOH
Biolabs Oxidizer products

In addition, sodium bicarbonate (NaHCO₃) will be used for emergency neutralization of the chlorine reactor. Safety Data Sheets (SDS) for all reagents and oxidizer products will be obtained (as needed) and should be reviewed prior to testing by all personnel involved in the testing.

The HCl and NaOH are compounds that are used frequently in the laboratory, and no additional controls are required.

The oxidizer products will require special handling because they are reactive when contacted with water and can form explosive gases. They should be kept in their original container away from moisture until they are used. Any unused material should be completely contained in plastic, marked with the name of the product and date, and kept away from moisture.

An LDPE liner will be used for spill control in the hood. LDPE is compatible with HCl, NaOH, and NaOCl. Although LDPE is not very compatible with chlorine gas, the contact with the gas should be minimal and the incompatibility is not expected to be a problem. The liner will contain up to 13.5 gallons (51 L).

Reaction Hazards

The reactions that will be performed as part of the work plan will generate chlorine gas. Specific exposure data, including symptoms of exposure, emergency response, and OSHA permissible exposure limits (PELs) for chlorine gas are presented below. A chlorine monitor will be present in the working space (outside of the hood) and the alarm will be set to 0.5 ppm. Note that in the event of a catastrophic release, the evacuation distance is 300 feet in all directions (based on the maximum amount of Cl₂ that can be generated, assuming a mixing zone 1 m high and a safe chlorine concentration of 0.5 ppm.)

| | |
|---|---|
| OSHA Ceiling Limit | 1 ppm |
| OSHA 8-hour TWA | 0.5 ppm |
| Symptoms of exposure | Eye Contact: pain, watering, redness |
| | Inhalation: respiratory tract irritation, |
| | coughing |
| | Skin Contact: pain or irritation, redness, |
| | blistering |
| Respirator | 5 ppm: Any Air-purifying half-mask respirator |
| Recommendations | equipped with chlorine cartridges or any air |
| | supplied respirator. APR = 10 |
| | 10 ppm: Any supplied air respirator operated |
| | in continuous-flow mode OR any powered |
| | air-purifying respirator with a chlorine |
| | cartridge OR Any air-purifying full-face |
| | respirator equipped with chlorine |
| | cartridges OR Any air-purifying, full face |
| | respirator (gas-mask) with a chin-style, |
| | front or back-mounted chlorine canister |
| | OR Any SCBA with a full facepiece OR |
| | Any supplied air respirator with a full |
| | facepiece. APR = 25 |
| | Higher levels: Any supplied air respirator that |
| | has a full facepiece and is operated in a |
| | pressure-demand or other positive pressure |
| | mode in combination with an auxiliary |
| | SCBA operated in a pressure-demand or |
| | other positive pressure mode OR Any |
| | SCBA that has a full facepiece and is |
| | operated in a pressure-demand or other |
| | positive pressure mode. APR = 10,000 |

Given the small quantities of the materials being used and the use of a hood, the potential for personnel exposure to chlorine gas at a level at or above the PEL is unlikely. However, a chlorine monitor will be used to monitor the workspace outside of the hood for the chlorine concentration. The alarm will be set at 0.5 ppm. This same monitor will be used to determine when the concentration in the reactors is safe. The chlorine generation reaction can be stopped by adding the appropriate amount of sodium bicarbonate (NaHCO₃) to the chlorine reactor. The appropriate amount will be kept in the hood in a flask in case of emergency.

Because chlorine gas has a vapor density greater than 1 (heavier than air), it will tend to collect in low lying areas.

The following table summarizes responses to worst-case scenario incidents.

| Incident | Response |
|---|---|
| Chlorine concentration | Personnel will evacuate 300 feet in all |
| outside of hood | directions. One designated worker will don an |
| exceeds 0.5 ppm. | escape respirator and add the emergency |
| | NaHCO₃ to the chlorine reactor and then |
| | evacuate. After 30 minutes, personnel wearing |
| | a respirator will monitor the area for safe levels |
| | of chlorine. Keep un-protected personnel |
| | away until concentrations are at acceptable |
| | limits. |
| Loss of Power/Loss | Personnel will evacuate 300 feet in all |
| of Hood Function | directions. One designated worker will don an |
| | escape respirator and add the emergency |
| | NaHCO₃ to the chlorine reactor and then |
| | evacuate. After 30 minutes, personnel wearing |
| | a respirator will monitor the area for safe levels |
| | of chlorine. Keep un-protected personnel |
| | away until concentrations are at acceptable |
| | limits. Restore ventilation when available. |
| Spill from Chlorine | The spill containment will hold the volume of |
| reactor | the reactor. The emergency NaHCO₃ should |
| | be added to the spill tray, and allowed to react |
| | for at least 30 minutes. The resulting |
| | neutralized solution should then be cleaned up |
| | in accordance to USE spill containment |
| | procedures. |
| Spill from the Bleach | The spill containment will hold the volume of |
| Reactor | the reactor. The bleach solution should be |
| | cleaned up in accordance to USE spill |
| | containment procedures. |
| Spill from both reactors | Take the pH of the liquid in the tray. If the pH |
| | is lower than 5, add the emergency NaHCO₃. |
| | Then clean up the neutralized solution in |
| | accordance to USE spill containment |
| | procedures. |

PPE

Personnel will wear labcoats, close-toed shoes and safety glasses while in the laboratory. While handling chemicals, nitrile gloves will be worn (the compatibility of nitrile with chemical reagents is summarized in the following table. Gloves will be changed if any corrosion or discoloration is noted. While handling concentrated NaOH and HCl, a face shield will be used.

| Chemical | Compatibility Rating |
|---|---|
| Chlorine Gas (dry) | B—Good |
| Hydrochloric Acid, 37% | B—Good |
| Sodium Bicarbonate | A—Excellent |
| Sodium Hydroxide, 50% | A—Excellent |
| Sodium Hypochlorite, <20% | B—Good |

1. A process for generating a sodium hypochlorite solution from recycled solid oxidizer materials comprising:
the step of dissolving said oxidizer materials in a solution;
the step of producing chlorine gas;
the step of combining said chlorine gas with caustic soda to create a bleach solution.
